(19) United States
(12) Patent Application Publication
(10) Pub. No.: US 2012/0217155 A1
(43) Pub. Date: Aug. 30, 2012

(54) GAS GENERATING DEVICE

(76) Inventor: LLOYD H. WOODWARD, DUNN LORING, VA (US)

(21) Appl. No.: 13/400,469

(22) Filed: Feb. 20, 2012

Related U.S. Application Data
(60) Provisional application No. 61/446,490, filed on Feb. 24, 2011.

(51) Int. Cl. C25B 9/00; B82Y 99/00

(52) U.S. Cl. 204/242; 977/734

(57) ABSTRACT

An electrochemical device for generating gas is disclosed. The device may be used as a source of economical and clean energy. The device includes an anode, a cathode and an applied magnetic field in proximity to the anode and the cathode.

### CROSS REFERENCE TO RELATED APPLICATIONS

This application claims priority to co-pending U.S. Provisional Application No. 61/446,490 entitled, “Gas Generating Device,” filed Feb. 24, 2011, which is incorporated herein by reference in its entirety.

### STATEMENT REGARDING FEDERALLY SPONSORED RESEARCH

The disclosure was partially made with U.S. Government support under Contract No. W81XWH-09-2-0010, which was issued by the U.S. Army Medical Research and Materiel Command (USAMRMC). The U.S. Government has certain rights in the invention.

### TECHNICAL FIELD

The disclosure relates generally to a gas generating device.

### BACKGROUND

There is a need for a renewable, clean energy source to replace petro-chemicals. Global warming has increased the desire to find an alternative to oil and its by-products. Since the 1950s scientists have been looking for a system that could fulfill the promise of the hydrogen fuel cell and provide a clean source of energy. Scientists agree that hydrogen fueled fuel cells, wherein the hydrogen has been produced from water, is the most favored solution.

Scientists have been searching for a catalyst to make the electrolysis of water into hydrogen and oxygen or Ethane an economical system to provide clean energy. However, the search has been unsuccessful. Without a catalyst, the process requires large energy expenditures to decompose water into its gas components and generate hydrogen to be used as fuel.

Millions of dollars have been spent on projects to find an economically viable method or system for generating hydrogen as a fuel, but progress has been slow. While hydrogen energy fuels have been costly to generate and the systems for home energy supplements have been something that only the very wealthy may afford, the R&D has remained focused on electrolysis of water as being the answer for clean, affordable energy for the world. There is an identifiable need for a system capable of providing large amounts of economical, clean energy, such as hydrogen fuel, without expending large amounts of energy to generate it.

### SUMMARY

The invention addresses the above shortcomings by providing an advanced hydro-magnetic kinetic chemical reaction hydrogen generating system that combines a magnetic field with a low cost electrolyte. This system provides economical, clean energy while reducing the required energy needed to produce hydrogen in an electro-chemical reaction.

It is an aspect of this invention to provide a gas generating device that decomposes water and is scalable so that it may fuel any size Proton Exchange Menihrane (PEM) fuel cell to provide energy. For example the energy may be utilized for commercial use, household appliances, toys, cars and home energy.

It is a further aspect of the invention to provide a gas generating device that uses a magnetic field to accelerate a kinetic chemical reaction to produce hydrogen.

It is a further aspect of the invention to provide a gas generating device comprising a stainless steel alloy for the electrodes.

It is a further aspect of the invention to provide a gas generating device comprising an alloy for the anode and cathode and to shape the anode and cathode to adjust the amount of surface contact with the electrolyte. For example, micro-etching both the anode and the cathode manipulate the rate of reaction and thereby manipulate the rate of production of hydrogen and oxygen.

It is a further aspect of the invention to provide a gas generating device comprising a stainless steel alloy for the anode and cathode and to install additional or multiple anodes and cathodes to further manipulate the rate of production of hydrogen and oxygen.

There has thus been outlined, rather broadly, the more important features of the invention in order that the detailed description thereof that follows may be better understood, and in order that the present contribution to the art may be better appreciated. There are, of course, additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception upon which this disclosure is based may be readily utilized as a basis for the designing of other structures, methods and systems for carrying out the several purposes of the invention. It is important, therefore, that equivalent constructions insofar as they do not depart from the spirit and scope of the invention, are included in the invention.

For a better understanding of the invention, its operating advantages and the aims attained by its uses, references should be had to the accompanying drawings and descriptive matter which illustrate embodiments of the invention.

### BRIEF DESCRIPTION OF THE DRAWINGS

FIG. 1 depicts a gas generating device according to the invention; and

FIG. 2 shows the applied magnetic fields according to the invention.

### DETAILED DESCRIPTION

The invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

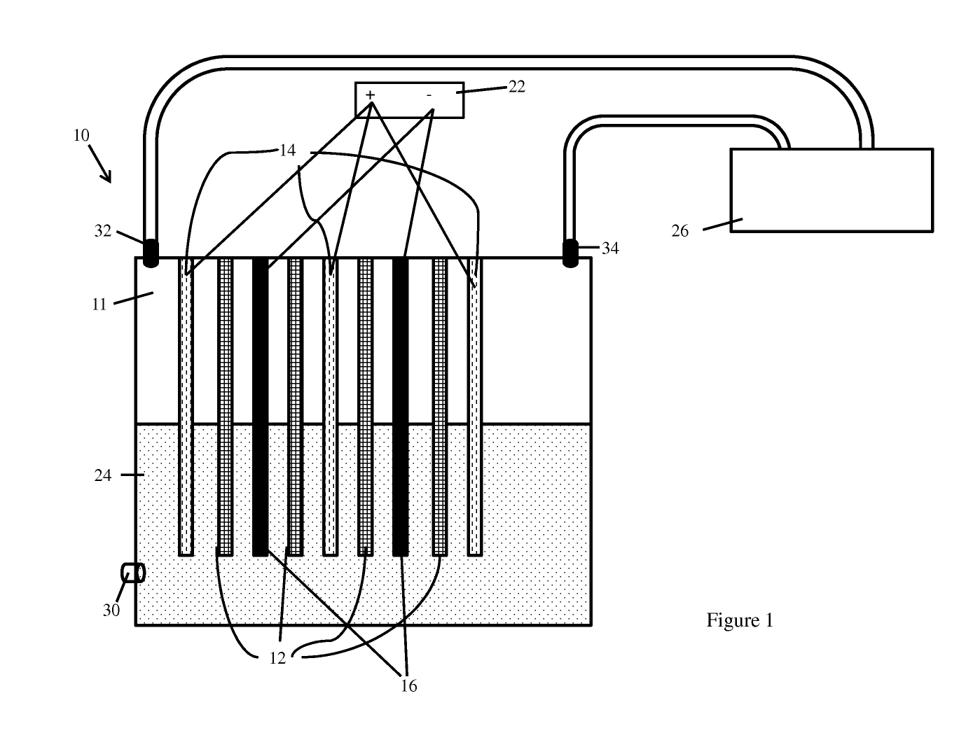

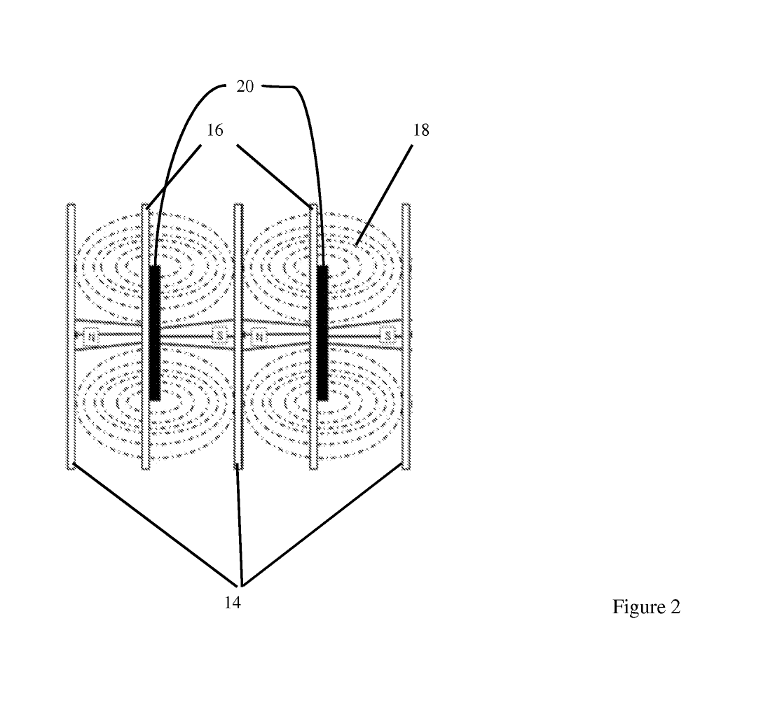

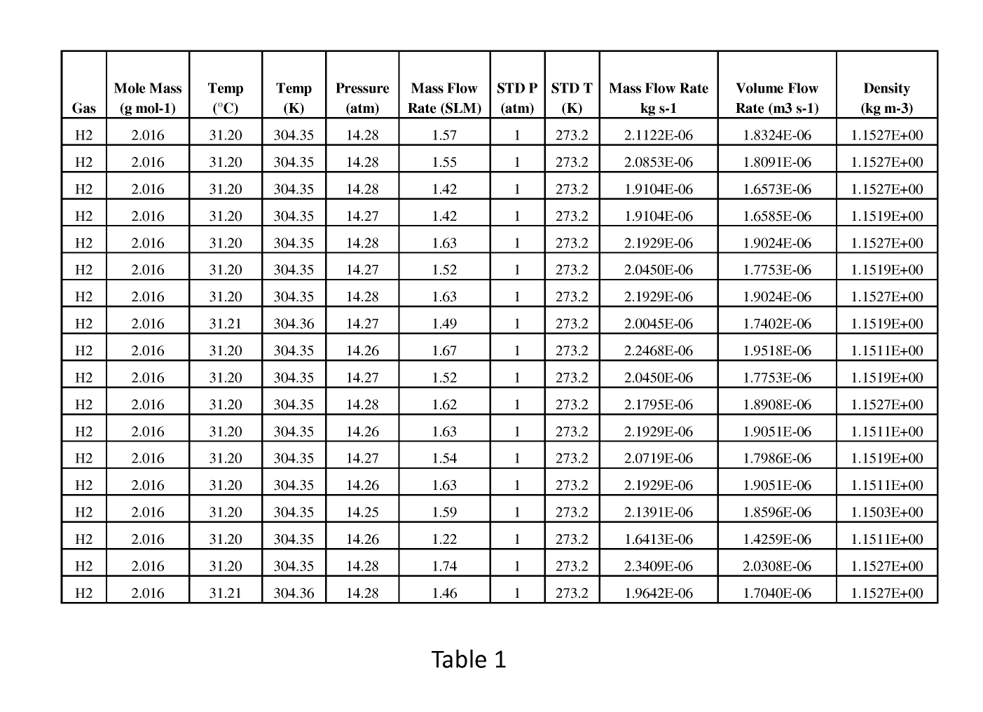

FIG. 1 is an illustrative embodiment of an electrochemical device for generating gas 10 from an electrolyte solution 24. The electrochemical device 10 includes an anode 14, cathode 16, and an applied magnetic field 18 shown in FIG. 2 in proximity to the anode 14 and cathode 16.

The applied magnetic field 18 acts similar to a catalyst in that it decreases the amount of energy required for the reaction. The magnet 20 or magnetic material create an overlapping parallel magnetic/electric field 18 that is around the cathode 16, which increases the flow of hydrogen ions from the anode 14 to the cathode 16. The applied magnetic field 18 may be generated in several ways, including but not limited to, the cathode 16 may be made of a magnetic material, a magnet 20 may be attached to the cathode, a magnetic material or magnet 20 in proximity to the anode 14 and the cathode 16, or combinations thereof. For example, the magnetic material/magnet 20 may be arranged in the interior of the chamber 11 or exterior of the chamber 11 so long as the applied magnetic field 18 creates a parallel magnetic/electric field around the cathode 16. Any magnet will function within the electrochemical device 10. Preferably, the magnetic material and/or magnet 20 is a super strength magnet such as a rare earth magnet or an experimental magnet like FE₁₆N₂. However, other suitable magnets/magnetic materials, e.g., Nd, Fe, Ni, Cu, Cr, Gd, Y, La, Co, a ceramic, derivatives and combinations thereof could be used.

In an embodiment, the applied magnetic field 18 is in a direction that generally bisects a magnetic field of the anode 14. The invention is not limited to bisecting the magnetic field of the anode 14 because the magnetic field may range from 0 degrees to 360 degrees about the cathode 16. For example, the applied magnetic field 18 has a negative polarity facing in a general direction of the anode 14 and a positive polarity facing in a general direction away from the anode 14. In an example, a rare earth magnet, e.g., Neodymium 52, which produces approximately 12 k Gauss magnetic field, is placed in proximity to or attached to the cathode 16.

The cathode 16 may be made of 430 stainless steel, but other suitable materials, e.g., Pt, Au, or the like, could likewise be used. To increase the surface area of the cathode 16 and to increase the reaction rate of the decomposition of the electrolyte solution 24, the cathode 16 may be at least partially resurfaced by holes, micro-etching, sandblasting, pebbling, or other suitable technique.

The anode 14 may be made of any suitable material, such as 316 stainless steel. To increase the surface area of the anode 14 and to increase the reaction rate of the decomposition of the electrolyte solution 24, the anode 14 may be at least partially resurfaced by holes, micro-etching, sandblasting, pebbling, or other suitable technique. The anode 14 may also have a nanoparticle layer over the resurfaced surface. Alternatively or additionally, the anode 14 may have at least a partial layer of graphene, fullerene, or similar type material over the resurfaced surface. If graphene is used in this configuration, the system operates virtually as a superconductor and substantially increases the production of hydrogen. The graphene on the surface of the anode 14, acting as a super conductor also makes a near perfect magnetic field around the current, which being substantially perpendicular or 90 degree intersection angle causes a near perfect “magnetic moment” or magnetic force to accelerate the creation of hydrogen ions; thereby controlling the flow of the hydrogen ions to form as molecules on the cathode 16 producing hydrogen at an increased rate.

Additionally, the electrochemical device 10 may be configured with multiple anodes 14, cathodes 16, and dividers 12. Generally, in this configuration, the electrochemical device 10 has alternating anodes 14 and cathodes 16, which are separated by dividers 12, situated substantially parallel to one another. In this instance, the hydrogen formation may occur on either or both sides of the cathode 16. In this configuration, the anodes 14 and cathodes 16 may be separated from the divider 12 by a distance of about 1.5 to 2.8 mm, more preferably about 2.6 to 2.8 mm. In an embodiment, the anodes 14 may make a common connection and the cathodes 14 may make separate connections. In another embodiment, the anodes 14 and cathodes 16 are arranged in alternating sequence around the perimeter of the chamber 11 and wherein the anodes 14 and cathodes 16 are substantially parallel to each other.

The anode 14 and cathode 16 may be plate shaped, but any other shape that maximizes the contact with the electrolyte solution 24 may be used. For example, the anode 14 and cathode 16 may have dimensions of approximately 51 mm×102 mm×1.59 mm. Other dimensions could be utilized. Additionally, the anode 14 and cathode 16 may have holes such as to increase the contact area with the electrolyte solution 24 to increase the reaction rate of the decomposition of the electrolyte solution 24. For example, the holes may be approximately 3.2 mm in diameter, but other dimensions could be utilized.

As shown in FIG. 1, the electrochemical device 10 may be box-shaped and may be made of acrylic plastic or polypropylene sulfate (PPS). Other suitable shapes and materials may be utilized so long as the electrochemical device 10 is sealed to not allow fluid or gas to escape. The electrochemical device 10 has an input 30 for filling a chamber 11 with the electrolyte solution 24, an output for a first gas output 32, and an output for a second gas 34. Typically, the electrochemical device 10 generates hydrogen, which exits via the first gas output 32, and oxygen, which exits via the second gas output 34. However, other gases may be formed. By way of example, hydrogen and oxygen will be used to explain the function of the electrochemical device 10. In a sample configuration, the first gas output 32 is located nearer to the cathode 16 and the second gas output 34 is located nearer to the anode 14. Other configurations may also be used.

The electrochemical device 10 may also include a divider 12 that separates the anode 14 from the cathode 16. Generally, the divider 12 has a length longer than that of the anode 14 and cathode 16. For example, in an embodiment, the divider 10 separates about ⅓ of the volume of the chamber 11 for the cathode 16 and ⅔ of the chamber 11 for the anode 14. In another embodiment, the divider 12 is suspended from the top of the chamber 11 to about ⅞ of the total distance from the top of the chamber 11 to the bottom of the chamber 11 such that the remaining ⅛ of the height at the bottom of the chamber 11 is left open to allow the electrolyte solution 24 and ions to move freely between the anode 14 and cathode 16. In another embodiment, the divider 12 may have a plurality of openings to allow the electrolyte solution 24, ions, and/or generated gas to pass freely.

The electrolyte solution 24 used in the electrochemical device 10 is typically acid based. The electrolyte solution 24 may be sodium chloride, sodium hydroxide, potassium chloride, potassium hydroxide, sodium acetate, acetic acid, hydrogen peroxide, and combinations thereof.

For example, the electrolyte solution 24 may have a pH of about 3 to 4 when initially mixed and a pH of 12 to 14 when reacted inside the electrochemical device 10. In an embodiment, the electrolyte solution 24 may include about 40-180 g, preferably 40-80 g, more preferably about of 63.3 g of sodium hydroxide in 500 ml of water (13% by volume). The solution may also comprise about 1-10 g, more preferably about 1.3 g of acetic acid in 500 ml of water. The acetic acid causes a “sheeting” action or Marangoni effect on the surface where the hydrogen is generated; further resurfacing can be done in geometric shapes causing a hydrophilic action, all aiding and causing the formed hydrogen gas to flow away from the plate and release more rapidly. According to another embodiment, the electrolyte may comprise about 8-40% by volume potassium chloride, preferably 13% by volume, instead of sodium chloride. In an embodiment, the electrolyte solution 24 includes about 38 g sodium acetate and about 3 mg acetic acid in about 500 ml water, which produces hydrogen at the cathode 16 and ethane at the anode 14.

The formed gas may be utilized directly or may need to be purified and/or dried for storage, transport, and/or use. The electrochemical device 10 may also include a purification apparatus and/or a drying apparatus 26. In such a case and by way of example, the hydrogen and oxygen may feed directly into the purification and/or drying apparatus 26 such as a Proton Exchange Membrane (PEM), a molecular sieve, a vapor chamber, or other suitable apparatus. For example, as the hydrogen and oxygen flow through the PEM, water and energy, i.e., electricity, are generated. The water generated by the electrochemical device 10 is substantially free of all types of contaminants, including bacteria, which allows the water to be drinkable or used for various applications, such as for medical uses. Additionally, the electrochemical device 10 may be scaled to sufficiently supply various size PEMs. For example, the electrochemical device 10 may supply a PEM that is about 25 watt (24-membrane stack). In another embodiment, the electrochemical device 10 may supply a PEM that is 65,000 watt. Other PEM sizes are also contemplated.

The electrochemical device 10 may also include a molecular sieve for purifying the gas. The molecular sieve may contain aluminosilicate minerals, clays, porous glasses, microporous charcoals, zeolites, active carbons, or similar compounds through which small molecules can diffuse. In the case of ethane, the molecular sieve separates the carbon-containing material from the hydrogen. If needed, the gas produced may then pass from the molecular sieve into a vapor chamber.

In order to power the electrochemical device 10, a low energy source 22 is in electrical contact with the anode 14 and cathode 16. The anode 14 is generally connected to the positive and the cathode 16 is generally connected to the negative/ground. Examples of the low energy source 22 include a solar cell, wind turbine, a battery, and combinations thereof. Other low energy sources could also be used. For example, the electrochemical device 10 may be powered with about 50 mA at about 1 V to about 5 A at about 12 V to sustain the electrolysis reaction. In another example, the electrochemical device 10 may be powered with about 440 mA at about 3 V.

Additionally, the electrochemical device 10 may also comprise a pump, such as a water pump, to circulate the electrolyte solution 24 and/or a filter to remove undesirable materials such as precipitates that may slow or terminate the reaction.

Not limited by theory, combining both magnetohydrodynamics (MHD) and convective diffusion theory (CDT) allows a flow generated at horizontal conducting surfaces in parallel magnetic/electric fields to propagate according to a snowballing sequence, which starts at a small local area on the surface, where the electric current is slightly non-uniform at the onset of the reaction. The interaction of these currents with the magnetic fields gives rise to non-uniform flow, which becomes increasingly pronounced in time. This mode of flow propagation, which in fluid mechanics is called “anisotropic”, is useful in accelerating hydrogen ion flow.

During operation, the electro-chemical reaction in the electrochemical device 10 is actually a series of half reactions that are initiated by an energy source 22 creating a low energy current being placed on the anode 14. This causes a snowballing effect on the anode 14, which releases numerous hydrogen ions from the sodium or potassium solute, turning the solute almost instantly into a very strong base with the pH level going from acidic to basic, in a very short time period. The reaction of the anode 14 producing hydrogen ions continues as long as the low energy current is maintained on the anode 14. Upon removal of the low energy current from the anode 14 the reaction continues as a chemical reaction for a short period of time and then gradually stops, with the pH returning to approximately 7. During operation, little to none of the anode 14 material is consumed during the reaction cycle; thereby creating large amounts of economical, clean energy without expending large amounts of energy to generate it.

When a small electric current is passed over the face of the anode 14, a small magnetic field accompanies the current. An interaction between this magnetic field and the field of the cathode 16 causes the hydrogen ions to flow directly to the cathode 16. This reaction is sustained using very low levels of current on the anode 14, which increases hydrogen formation at the cathode 16.

As part of the reaction, a small amount of chlorine is released into the solute, but as a reversible reaction, which creates a mixture of hydrochloric acid and hypochlorous acid. Light decomposes the hypochlorous acid into hydrochloric acid releasing oxygen at the anode 14. This reaction may be further accelerated if the reaction occurs in bright light, such as sunlight. In turn, the hydrochloric acid reacts with the anode 14 precipitating a small amount of calcium chloride, which will cloud the solute but not affect the reaction. The acetic acid in the solute is used as a buffering agent to adjust the pH of the solution and has a sheeting action on the cathode 16. When the current is stopped or removed, the reactions continue for a short while, but eventually stop when the pH is around 7. The acetic acid causes the initial pH to be about 3 and the half reactions raise the pH to about 12-14, which is maintained until the reactions are stopped at which time an almost immeasurable amount of hydrogen peroxide is also precipitated.

Also disclosed is a method for generating a gas. The method includes: a) providing an electrochemical device 10 having an anode 14, a cathode 16, and an applied magnetic field 18 in proximity to the anode 14 and the cathode 16; b) providing an electrolyte solution 24 to the electrochemical device 10; c) powering the electrochemical device 10 with an energy source 22; and d) generating at least one gas from the electrolyte solution 24 within the electrochemical device 10. The method further includes drying and/or purifying the generated gas. The method also includes, before or after drying and/or purifying, storing, transporting, and/or using the gas.

### EXAMPLES

### Example 1

As an example, the electrochemical device 10 supplied on board all the energy required for an unmanned aircraft vehicle (UAV) by using an electric engine with a hybrid lithium ion battery system. The electrochemical device 10 operated using 3 V at 440 mA, breaking down water into hydrogen and oxygen, i.e., creating hydrogen fuel, which was fed to a 25 watt PEM and produced 19.9 volts at 1.2 AMPS. This invention permits the electrochemical device 10 to provide on board decomposition of water into energy, i.e., electricity, for mobile requirements as well as for static environments. For example, the invention may be utilized where an energy source is needed, such as portable electronic devices, vehicles, homes and businesses.

### Example 2

Table 1 shows the results from an Alicat flow meter (Model No. M-20SLPM-D-30PSIA/SM) taking readings every 5 minutes starting from 61 g of sodium hydroxide in 500 mL of distilled H2O with input current of 440 mA at 4.5V to 316 stainless steel anode resurfaced with pyramid shaped nanotechnology, grapheme coated and 12K Gauss N52 Neodynium magnet on the 430 stainless steel cathode resurfaced with Femto-Laser fish-scale shaped nanotechnology.

Those skilled in the art will recognize yet other embodiments defined more particularly by the claims, which follow. Having now described a few embodiments of the invention, it should be apparent to those skilled in the art that the foregoing is merely illustrative and not limiting, having been presented by way of example only. Numerous modifications and other embodiments are within the scope of the invention and any equivalent thereto. It may be appreciated that variations to the disclosure would be readily apparent to those skilled in the art, and the invention is intended to include those alternatives.

Further, since numerous modifications will readily occur to those skilled in the art, it is not desired to limit the invention to the exact construction and operation illustrated and described, and accordingly, all suitable modifications and equivalents may be resorted to as falling within the scope of the invention.

What is claimed is:

1. An electrochemical device for generating gas comprising: an anode, a cathode, and an applied magnetic field in proximity to the anode and the cathode.

2. The device of claim 1, further comprising a divider separating the anode from the cathode.

3. The device of claim 1, wherein the applied magnetic field is generated by the cathode comprising a magnetic material, a magnet attached to the cathode, a magnetic material or magnet in proximity to the anode and the cathode, or combinations thereof.

4. The device of claim 3, wherein the magnetic material selected from the group consisting of Nd, Fe, Ni, Cu, Cr, Gd, Y, La, Co, a ceramic, derivatives and combinations thereof.

5. The device of claim 1, further comprising a low energy source selected from the group consisting of a solar cell, wind turbine, a battery, and combinations thereof.

6. The device of claim 1, wherein the anode comprises grade 316 stainless steel.

7. The device of claim 1, further comprising alternating anodes and cathodes situated substantially parallel to one another.

8. The device of claim 1, wherein the anode, cathode, or both are at least partially resurfaced.

9. The device of claim 8, wherein the anode further comprises a nanoparticle layer over the resurfaced surface.

10. The device of claim 8, wherein the anode comprises at least a partial layer of grapheme over a resurfaced surface.

11. The device of claim 1, further comprising an electrolyte solution.

12. The device of claim 11, wherein the electrolyte solution is selected from the group consisting of sodium chloride, sodium hydroxide, sodium nitrate, potassium chloride, potassium hydroxide, sodium acetate, acetic acid, hydrogen peroxide, and combinations thereof.

13. The device of claim 1, further comprising a purification apparatus, drying apparatus, or combinations thereof.

14. The device of claim 1, wherein the applied magnetic field is in a direction that generally bisects a magnetic field of the anode.

15. The device of claim 1, wherein the applied magnetic field comprises a negative polarity facing in a general direction of the anode and a positive polarity facing in a general direction away from the anode.

16. An electrochemical device for generating gas comprising: a divider separating an anode from a cathode, wherein the cathode comprises an applied magnetic field in proximity thereto.

17. The device of claim 16, wherein the cathode comprises a magnet, a magnetic material, or combinations thereof for generating the applied the magnetic field.

18. The device of claim 16, wherein the magnet or magnetic material is selected from the group consisting of Nd, Fe, Ni, Cu, Cr, Gd, Y, La, Co, a ceramic, derivatives and combinations thereof.

19. The device of claim 16, wherein the applied magnetic field is in a direction that generally bisects a magnetic field of the anode.

20. The device of claim 16, wherein the anode, cathode, or both are at least partially resurfaced.
